(19) United States
(12) Patent Application Publication
(10) Pub. No.: US 2024/0394412 A1
(43) Pub. Date: Nov. 28, 2024

(54) DATA PRIVACY INCONSISTENCY DETECTION

(71) Applicant: The Regents of the University of Michigan, Ann Arbor, MI (US)

(72) Inventors: Kang SHIN, Ann Arbor, MI (US); Hoang Duc BUI, Santa Monica, CA (US)

(21) Appl. No.: 18/671,212

(22) Filed: May 22, 2024

Related U.S. Application Data
(60) Provisional application No. 63/468,238, filed on May 22, 2023.

(51) Int. Cl. G06F 21/62

(52) U.S. Cl. CPC G06F 21/6263

(57) ABSTRACT

An automated data collection-disclosure consistency determination system and method of detecting inconsistencies between privacy policy disclosures and practices. The automated data collection-disclosure consistency determination system is configured to perform the method, which includes: generating dashboard disclosure privacy statements based on dashboard disclosure data for an extension; generating privacy policy statements based on privacy policy data for the extension; determining privacy contradiction data between the dashboard disclosure privacy statements and the privacy policy statements; generating extension use data for the extension based on data collected during operation of the extension; and determining inconsistencies between extension data practice and an extension privacy policy based on the dashboard disclosure privacy statements, the privacy policy statements, and the extension use data.

### TECHNICAL FIELD

The invention is related to detecting inconsistencies in data privacy policies and/or practices of software products, for example, browser extensions or plug-ins.

### BACKGROUND

Supplementary software components, known as extensions or plug-ins, enhance the functionality of a larger software application or system by providing specific features and/or capabilities, enriching its overall functionality. A browser extension is one such example that is specifically geared toward enhancing the functionality of a web browser. A browser extension or plug-in (referred to as a “browser extension”) is typically installed by users in order to customize their browsing experience. In some instances, browser extensions are able to modify the user interface, manage cookies, block ads, and enable custom scripting and styling of web pages, for example.

In some contexts, these software components that extend the functionality of a host application are referred to as extensions and, in other contexts, are referred to as plug-ins or add-ons. Extensions or plug-ins are treated one in the same generally herein, and the term “extension” as used herein covers various types of extensions and plug-ins that are used to extend functionality of a host application. Extensions are used in various software contexts, not limited to web browsers. As some examples, in text editors, extensions can provide additional editing features or support for specific programming languages; in media players, plug-ins can enable support for various audio or video codecs; and, in graphics software, extensions can offer new filters or tools for image editing. The specific purpose and functionality of an extension depend on the context and the software it is intended to extend.

While extensions have greatly enhanced a user's experience, extensions can also pose security risks, as they can access sensitive data, alter browser settings, and sometimes be used to distribute malware. Web browser users are able to easily install extensions via extension stores or software distribution platforms. Due to integration with web browsers, extensions may collect highly-sensitive data, such as personally identifiable information (PII) and content that users input to a web page. These types of data can then be collected by the extensions themselves or transferred to third parties. This is generally true with extensions in other contexts as well.

Although the extensions generally inform users of their data practices via multiple forms of notices, prior work has overlooked the critical gap between the actual data practices and the published privacy notices of browser extensions.

### SUMMARY

In accordance with an aspect of the disclosure, there is provided a method of detecting inconsistencies between privacy policy disclosures and practices. The method includes: generating dashboard disclosure privacy statements based on dashboard disclosure data for an extension; generating privacy policy statements based on privacy policy data for the extension; determining privacy contradiction data between the dashboard disclosure privacy statements and the privacy policy statements; generating extension use data for the extension based on data collected during operation of the extension; and determining inconsistencies between extension data practice and an extension privacy policy based on the dashboard disclosure privacy statements, the privacy policy statements, and the extension use data.

According to various embodiments, this method may further include or be further characterized by any one of the following features or characterizations, including any technically-feasible combination of some or all of these features or characterizations:
the dashboard disclosure privacy statements are extracted as dashboard disclosure statement data items, each of which includes a receiver identifier, a collection indicator, and a data type identifier;
the privacy policy statements are extracted as privacy policy statement data items, each of which includes a receiver identifier, a collection indicator, and a data type identifier;
the determining privacy contradiction data between the dashboard disclosure privacy statements and the privacy policy statements includes determining mismatches between the dashboard disclosure statement data items and the privacy policy statement data items by comparing, for each dashboard disclosure statement data item of the dashboard disclosure statement data items, the collection indicator with the collection indicator of a corresponding privacy policy statement data item of the privacy policy statement data items;
the determining privacy contradiction data between the dashboard disclosure privacy statements and the privacy policy statements includes determining subsumptive relationships between the receiver identifiers and the data type identifiers;
determining the subsumptive relationships between the receiver identifiers includes determining whether there exists a subsumptive relationship between the receiver identifier of a first privacy policy statement data item and the receiver identifier of a second privacy policy statement data item;
determining the subsumptive relationships between the data type identifiers includes determining whether there exists a subsumptive relationship between the data type identifier of a first privacy policy statement data item and the data type identifier of a second privacy policy statement data item;
generating the extension use data for the extension based on data collected during operation of the extension includes performing a network request initiator inspection process where an initiator of a network request is inspected to determine whether the network request was initiated from the extension;
generating the extension use data includes extracting data types from one or more extension network requests so as to generate extension use data items, each of which includes a receiver and a data object that is sent as a part of the network request to the receiver;
the extension is a browser extension for a web browser; and/or
the method is performed by at processor executing computer instructions stored on non-transitory, computer-readable memory.

According to another aspect of the disclosure, there is provided an automated data collection-disclosure consistency determination system, including: at least one processor; and memory storing computer instructions. The automated data collection-disclosure consistency determination system is configured to perform the method through executing the computer instructions using the at least one processor. The automated data collection-disclosure consistency determination system may be further characterized by any one or more of those features discussed above in connection with the method.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram illustrating a communications system having an automated data collection-disclosure consistency determination system (or “automated consistency determination system”), where the system is used to detect inconsistencies between privacy policy disclosures and practices, according to one embodiment;

FIG. 2 is a flowchart illustrating a method of detecting inconsistencies between privacy policy disclosures and practices, according to one embodiment;

FIG. 3 is a block diagram and flowchart illustrating an automated consistency determination system according to one embodiment, referred to as ExtPrivA, according to one embodiment;

FIG. 4 is an exemplary dashboard disclosures used by the Chrome™ Web Store, for example;

FIGS. 5A-5B are data type examples for disclosures in the Chrome™ Web Store policies;

FIG. 6 is a diagram depicting the number of the privacy-disclosure types; and

FIG. 7 is a block diagram illustrating a dynamic analysis performed by ExtPrivA, which captures data traffic of the extensions using an analysis pipeline, according to one embodiment.

### DETAILED DESCRIPTION

There is provided a system and method that enables automatically detecting inconsistencies between data collection practices of a browser extension and its corresponding privacy disclosures, including any responsive or form-based privacy disclosures (referred to as “dashboard disclosures”) and privacy policies (referred to as “free-form disclosures”).

According to embodiments, there is provided a method of detecting inconsistencies between privacy policy disclosures and practices, and this method includes: generating dashboard disclosure privacy statements based on dashboard disclosure data for a software extension (referred to as an extension); generating privacy policy statements based on privacy policy data for the extension; determining privacy contradiction data between the dashboard disclosure privacy statements and the privacy policy statements; generating extension use data for the extension based on data collected during operation of the extension; and determining inconsistencies between extension data practice and an extension privacy policy based on the dashboard disclosure privacy statements, the privacy policy statements, and the extension use data.

An end-to-end automated framework embodying the method is used to automatically detect inconsistencies between data collection/use practices and privacy disclosures, and this framework is referred to as “ExtPrivA” in the browser extension-based embodiment discussed below. Although the embodiment below discusses this framework in a browser extension context, it will be appreciated that this framework is adaptable to many other software frameworks having plug-ins or other extensions.

From the privacy policies and dashboard disclosures, ExtPrivA extracts privacy statements to obtain a clear interpretation of the privacy practices of a target extension. ExtPrivA also emulates user interactions to trigger the extension's functionalities and analyzes the initiators of network requests to accurately extract the users' data transferred by the extension from the web browser to external servers. An end-to-end evaluation has shown ExtPrivA to detect inconsistencies between the privacy disclosures and data-collection behavior with an 85% precision and, in a large-scale study of 47,200 extensions on the Chrome™ Web Store, 820 extensions with 1,290 flows that are inconsistent with their privacy statements were found. Even more, 525 pairs of contradictory privacy statements were found in the dashboard disclosures and privacy policies of 360 extensions. These discrepancies between the privacy disclosures and the actual data-collection behavior are deemed as violations of the Chrome™ Web Store's policies. Such findings highlight issues in the privacy disclosures of browser extensions that potentially mislead, and even pose high privacy risks to, end-users.

Further, obtaining knowledge about such discrepancies helps ensure visibility for all parties, and may be used to ensure compliance with various agreements or policies, such as those put in place by the custodian of the web browser, for example, Google™.

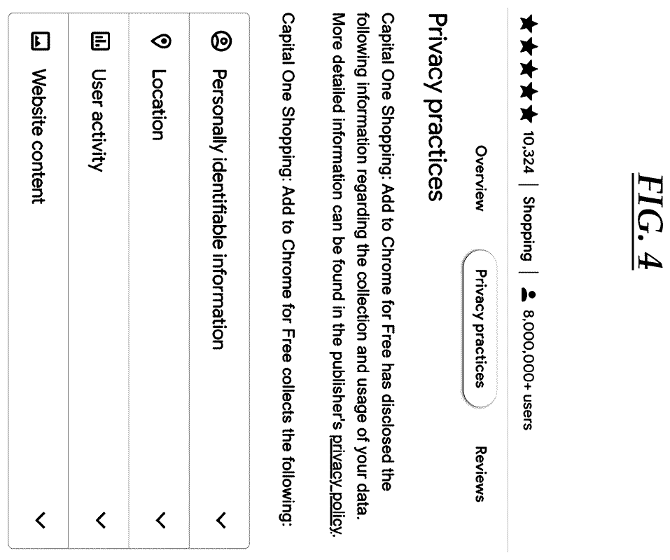

Many extension stores or distribution platforms have strict requirements on privacy practices to reduce privacy risks for users. For example, the Chrome™ Web Store requires extensions to provide privacy-practice disclosures via its developer dashboard along with the privacy policies. Herein, privacy policies generally refer to free-form documents while dashboard disclosures are based on a common form or template that is shared amongst extensions, such as the dashboard disclosures used by the Chrome™ Web Store as shown in FIG. 4. Discrepancies between the different forms of privacy disclosures and extensions' behavior may be considered a violation of the Store's developer program policies.

Because of the “non-discrepancy” requirements, data collection and practice for potentially benign purposes may still violate an extension's privacy policy if the collected data is not disclosed in the policy. For example, if an extension claims not to collect or use user data, then it would violate the privacy disclosures even when the extension collects the user's location and keystrokes only for debugging and product-analytics purposes. Prior work has largely overlooked the inconsistencies between an extension's execution behavior and its associated privacy policies. Due to their lack/inability of determining the legitimacy of data transfer, prior policy-agnostic detection techniques are only able to analyze common malicious user-data leakage. For example, such prior techniques only detect obvious malicious behavior (such as uninstalling other extensions) or check whether the privacy leakage is either accidental or intentional.

According to embodiments, the system and method are directed to detecting contradictions of statements in heterogeneous privacy disclosures. Checking inconsistencies between privacy policies and actual data collection requires unambiguous interpretations of privacy disclosures, which includes detecting any contradictions between the privacy statements themselves. Different privacy-disclosure forms pose a significant challenge due to the differences in their definitions of data types (or ontologies). A formal representation of privacy state from free-form privacy policies and template-based dashboard disclosures is derived and, finally, based on the extension distribution platform's data type specifications, a unified ontology is derived to leverage a privacy analysis (such as the one described by [D. Bui, Y. Yao, K. G. Shin, J.-M. Choi, and J. Shin. Consistency analysis of data-usage purposes in mobile apps. In Proceedings of the ACM SIGSAC Conference on Computer and Communications Security, 2021.] to detect the contradictions between privacy policies and dashboard disclosures.

According to embodiments, the system and method are directed to extracting actual data collection from extensions' behavior. Since extensions do not automatically execute their functionality while their data traffic only contains low-level key-values, ExtPrivA triggered an extension's functionality and inferred data types from its data traffic to extract its actual data-collection practices. ExtPrivA emulated user interactions on both real-world web pages and a honeypage to elicit the extensions' behavior that generated data traffic from the extensions to external servers. A request-initiator analysis is used to isolate the data traffic initiated by extensions. Finally, ExtPrivA extracted data types from key-value pairs in HTTP(S) requests and URL query strings.

According to embodiments, the system and method are directed to detecting flow-to-policy inconsistencies: The differences between the semantic granularities of data flows and privacy statements (low and high level) make it challenging to analyze their relationship and check the (in) consistency. From the extension distribution platform's policies, a data-object ontology used in the privacy-practice disclosures is extracted and used to analyze the relationship between data types in the flows and privacy statements. Finally, the consistency conditions between the data flows and the privacy statements represented in a formal model to detect their inconsistencies are established.

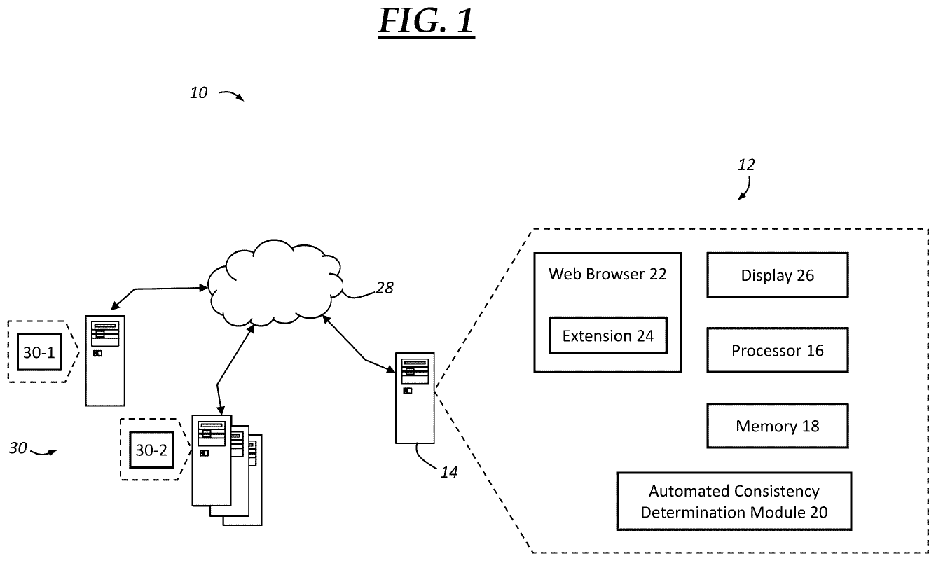

With reference to FIG. 1, there is shown a communication system 10 that includes an automated data collection-disclosure consistency determination system (or “automated consistency determination system”) 12, according to one embodiment, where the automated consistency determination system 12 is used to detect inconsistencies between privacy policy disclosures and practices. The automated consistency determination system 12 is discussed in more detail below, and generally includes at least one processor and memory. For example, as shown in the embodiment of FIG. 1, a computer 14 having a processor 16 and memory 18 is used as a part of the automated consistency determination system 12. Further, the memory 18 includes computer instructions used to implement functionality of the automated consistency determination system 12, as embodied by an automated consistency determination module 20. The computer instructions, such as those for the automated consistency determination module 20, are accessible by the processor 16 and executable so as to cause the automated consistency determination system 12 to perform the method discussed herein.

The computer 14 further includes a web browser 22 having an extension 24 installed thereon. The web browser 22 is a software application that facilitates the retrieval and display of information from the World Wide Web, most often via the Hypertext Transfer Protocol (HTTP). In addition to processing standard web languages like Hypertext Markup Language (HTML), Cascading Style Sheets (CSS), and JavaScript, browsers also handle a wide range of file formats, thereby enabling the use of diverse internet content. Major examples of browsers include Google Chrome™, Mozilla Firefox™, and Microsoft Edge™. An important feature of modern web browsers is their support for third-party extensions or plug-ins, which may be downloaded from their respective extension distribution platforms: Chrome™ Web Store for Google Chrome™, Add-ons for Firefox™, and Microsoft Edge™ Addons for Edge™.

The web browser 22 is shown as including the extension 24, which is a browser extension in the illustrated embodiment and is referred to as a “target extension” (in the present embodiment) because this browser extension is the extension that is the subject of the automated consistency determination system 12. A browser extension is a software module that adds specific functionalities to a web browser through inclusion of custom code that is configured to run on the web browser (the “host application” for a browser extension). However, in other embodiments, the system and method disclosed herein may be used with other types of host applications and extensions. Turning back to the present embodiment, browser extensions are typically written using web technologies, such as HTML, JavaScript, and CSS. Browser extensions operate within the browser environment provided by the web browser (host application), and such extensions interact with the Document Object Model (DOM) of webpages in order to carry out their desired or intended functionality, which may include modifying content, behavior, and/or appearance (e.g., graphical user interface modifications). Further, browser extensions may also make use of browser-provided application programming interfaces (APIs) to manipulate tabs, modify network requests, and access local storage. Browser extensions, and many extensions generally, are distributed through extension distribution platforms, such as the Chrome™ Web Store for Google Chrome™, Add-ons for Firefox™, and Microsoft Edge™ Addons for Edge™. These extension distribution platforms are software distribution platforms that allow users to install and manage extensions.

A web browser extension generally includes four executable components: background scripts (or background pages), content scripts, web-accessible resources (WARs), and pop-up pages. These components are declared in a JavaScript Object Notation (JSON) manifest file, outlining the components and each's execution relationship with webpage(s). For instance, in the case of a Chrome™ extension, background scripts (Manifest V2) and service workers (Manifest V3) do not have a user interface and remain hidden from users. These executable components have a lifetime independent of other user-facing web pages and are able to access privileged extension APIs specific to Chrome™ (or web browser). Such executable scripts operate asynchronously to handle events triggered by other components and can communicate via message passing. Content scripts, another executable component, are injected into a web page and have the ability to read or modify the DOM tree, which is inaccessible by the background pages. The execution of these scripts may be configured to occur at the start or end of DOM loading. Furthermore, the JavaScript code of WAR resources is loaded and operates in the same context as the host pages. Lastly, pop-up pages, another executable component, are executed upon a user's click on the extension icon or through navigating to the extension's webpage, generally hosted at a specific URL having an extension identifier (ID), as discussed more below.

An extension in a browser is uniquely identified by an extension ID that can be used to access the resources included in the extension's package. Resources of an extension, such as its content scripts, have URLs prefixed with chrome-extension://<extension-id>. The ID is generated randomly when the extension is loaded to the browser but can be made to be a fixed value by specifying a key value in the extension manifest. It will be appreciated that the web browser environment discussed above may slightly differ in structure and functionality between different browsers and the respective extensions.

Because extensions are (at least oftentimes) event-driven applications that have multiple entry points to trigger their functionality, the manifest file provides extensions with a means to statically declare their static entry points. An extension may specify the URL patterns where the content scripts are executed when loading a webpage from a pattern-matched URL. The extension may also implement event handlers for extension actions (i.e., mouse clicks on the extension icon on the browser menu bar) and the activation of the extension's context-menu items. Finally, the extension may specify URL-match patterns in the host permissions in order to access web pages to which the extensions have access as indicated by the URL-match patterns. Also, the extension may specify URL-match patterns for web accessible resources in order to restrict the pages which can access the resources (e.g., JavaScript and CSS) included in the extension package.

In general, for web browsers, to enhance security for the web browser, only background scripts and pop-up pages bypass the same cross-origin resource sharing (CORS) policy and are permitted to send information to any servers without any restriction. By contrast, content scripts are subject to the CORS policy of the host webpages. Unless the server side allows CORS requests, content scripts cannot directly request resources or send information to an arbitrary external server other than the origin of the currently visiting URL.

The computer 14 also includes a display 26, which is an electronic display that displays information for viewing by a user. The display 26 may be any of a variety of suitable displays, such as an organic light emitting diode (OLED) display, a liquid crystal display (LCD), an LCD projector, etc. The display 26 is used to display the web browser 22 and the extension 24 for viewing by the user. Other computer peripherals for human-machine interfacing between the user and the computer 14 may be used as well, such as a keyboard, computer mouse, microphone, speaker, etc. These human-machine interface (HMI) devices may be used for interfacing with the extension 24, such as for providing input into the extension 24 and/or receiving output from the extension 24. The computer 14 includes other components, as will be appreciated by those skilled in the art, including, for example, appropriate network interface cards, drivers, power supply, etc.

Besides the computer 14, the communication system 10 includes an interconnected data network 28 used to carry out network communications between the computer 14 and one or more remote computers 30, where the term “remote” is used to refer to that which is not co-located with the computer 14. The interconnected data network 28 is a global electronic data communications infrastructure, such as the Internet, comprising a plurality of interconnected devices, generally a vast array of such devices, and communication protocols, operating in order to enable exchange and transmission of data across geographically-dispersed (or remote/non-co-located) locations.

Each of the one or more remote computers 30 is a computer that is located remotely from the computer 14, and each such remote computer 30 may receive data from the computer 14, such as data originating from the extension 24 (or otherwise). The illustrated embodiment depicts two exemplary remote computers 30, including a first remote computer 30-1 for which the custodian is a first party (the same party as the custodian of the extension 24) and a second remote computer 30-2 for which the custodian is a third party (i.e., a party other than the first party), although those skilled in the art will appreciate the vast number of remote computers that may be used.

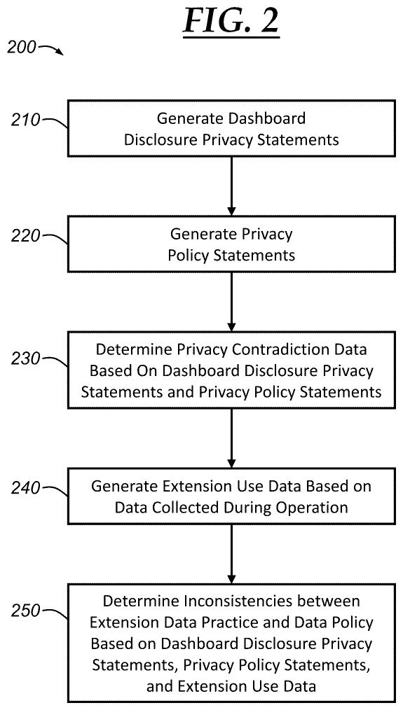

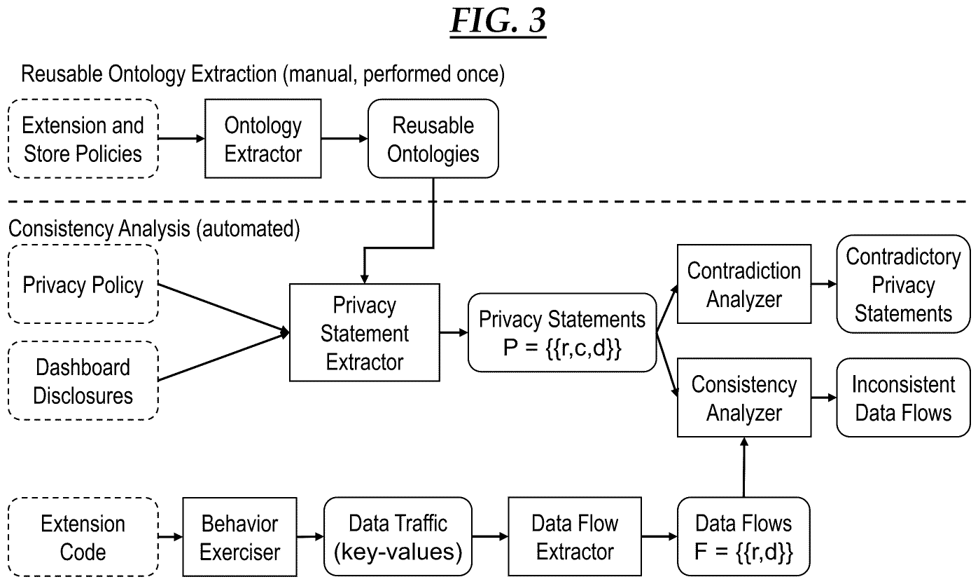

With reference to FIGS. 2-3, there is shown flowcharts illustrating an embodiment of a method 200 of detecting inconsistencies between privacy policy disclosures and practices (FIG. 2) and illustrating an exemplary end-to-end automated analysis pipeline that implements the method 200 through use of an automated consistency determination system according to one embodiment, referred to as ExtPrivA (FIG. 3). The method 200 is carried out by the automated consistency determination system 12, at least according to one embodiment. Although the steps of the method 200 are described as being carried out in a particular order, those skilled in the art will appreciate that the steps of the method 200 may be performed in any technically-feasible order, according to embodiments.

The method 200 begins with step 210, wherein dashboard disclosure privacy statements are generated based on dashboard disclosure data for an extension. As discussed above, the dashboard disclosures are privacy disclosures that are provided pursuant to privacy disclosure requirements set forth by an extension distribution platform, such as the Chrome™ Web Store. The dashboard disclosure privacy statements are extracted as dashboard disclosure statement data items, each of which includes a receiver identifier, a collection indicator, and a data type identifier.

The following discussion provides an example of extracting privacy statements from an extension's dashboard privacy-practice disclosures.

Let D={dᵢ} be the set of data types that the extension declares to collect and T be the set of all possible data types that an extension can declare. It is assumed that if an extension does not declare its collection of a data type dᵢ ∈T, then it will not collect dᵢ. The set of data types U not collected by the extension is then derived by excluding the stated data types from T:U=T\D={d′ᵢ|d′ᵢ∈T∧d′ᵢ∉D}. And, from D and U, the following privacy statements are created: S={(r,collect,dᵢ)|dᵢ∈D}∪{(r,not_collect,d′ᵢ)|d′ᵢ∈U}. For example, given the dashboard disclosures in FIG. 4 (where the extension states the collection of only 4 data types: PII, Location, User Activity, and Website Content), one has D={PII,location, user_activity,site_content} and the corresponding privacy statements are:

$$S = {S}_{c} ⋃ {S}_{n} ,$$

where:

$${S}_{c} = \{ ( extension , collect , {d}_{i} ) \vert {d}_{i} ∈ D \} \\ and \\ {S}_{n} = \{ ( extension , not \_ collect , {d}_{i}^{′} ) \vert {d}_{i}^{′} ∈ T \backslash D \} .$$

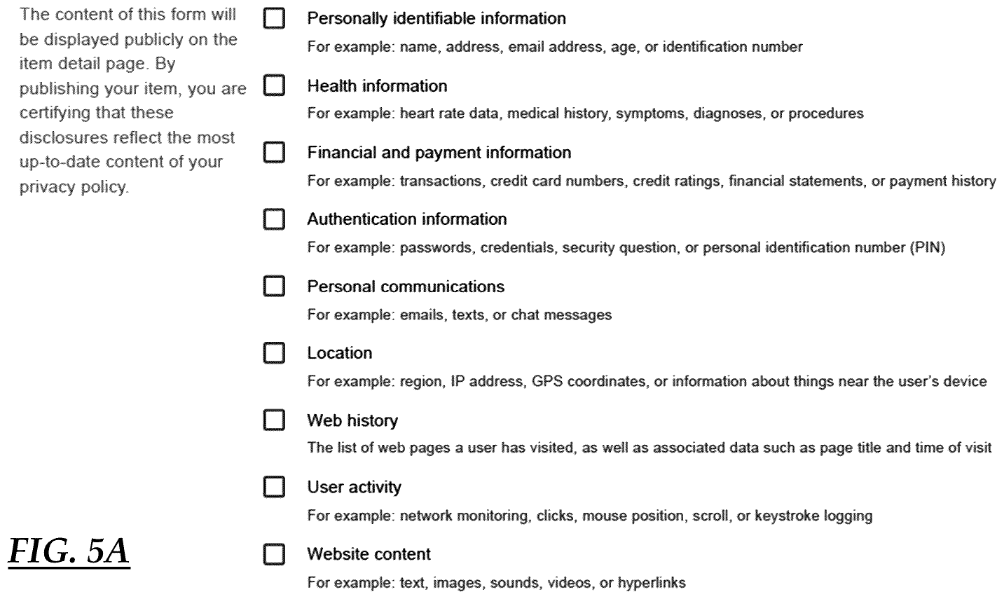

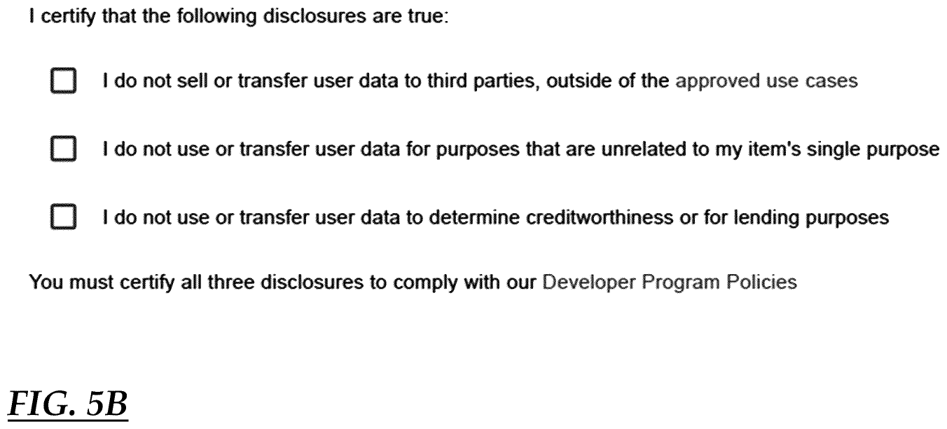

As an example, the Chrome™ Web Store specifies a total of nine (9) data types that an extension can declare. Therefore, in the present example, ExtPrivA extracts a total of |T|=9 privacy statements for each extension which comprise |D| positive-sentiment statements (i.e., with a collect action) for the declared data types D and 9−|D| negative-sentiment statements (i.e., with a not_collect action) for the undeclared data types in the extension's dashboard disclosures. Since the privacy-practice disclosures follow fixed declaration templates, D is extracted from the disclosures using regular expressions. All data type examples in the Chrome™ Web Store policies are listed in Table 1 below and FIGS. 5A and 5B.

TABLE 1
List of data types and examples specified by the Chrome ™ Web
Store policies

| | Data Type | Example |
|---|---|---|
| 1 | Personally | Name, address, email address, age, identification |
| | identifiable info. | number |
| 2 | Health | Heart rate data, medical history, symptoms, |
| | information | diagnoses, procedures |
| 3 | Financial and | Transactions, credit card numbers, credit ratings, |
| | payment info. | financial statements, payment history |
| 4 | Authentication | Passwords, credentials, security question, personal |
| | information | identification number (PIN) |
| 5 | Personal | Emails, text or chat messages, social media posts, |
| | communications | conference calls |
| 6 | Location | Region, IP address, GPS coordinates, information |
| | | about things near the user's device |
| 7 | Web history | The list of web pages a user has visited, browsing- |
| | | related data such as page title and time of visit |
| 8 | User activity | Network monitoring, clicks, mouse position, scroll, |
| | | keystroke logging |
| 9 | Website content | Text, images, sounds, videos, hyperlinks |

The method 200 continues to step 220.

In step 220, privacy policy statements based on privacy policy data for the extension are generated. The privacy policy statements are statements that are set forth by the first party (the custodian of the extension) and that generally correspond to a privacy policy that a company will put in place in addition to those policy responses set forth in the dashboard disclosures. In embodiments, the privacy policy statements are extracted as privacy policy statement data items, each of which includes a receiver identifier, a collection indicator, and a data type identifier.

Given the privacy policy of an extension, ExtPrivA adopts PurPliance [D. Bui, Y. Yao, K. G. Shin, J.-M. Choi, and J. Shin. Consistency analysis of data-usage purposes in mobile apps. In Proceedings of the ACM SIGSAC Conference on Computer and Communications Security, 2021.], a state-of-the-art privacy policy analysis technique, to extract privacy statements from the sentences in the document. For each sentence, the parameters of privacy statements (data type, collection action, and receiver) are determined by an NLP pipeline. The system first identifies the sharing-collection-and-use verbs in the sentence and then uses the semantic role labeling to extract the semantic arguments (e.g., subjects and objects) of each verb. The data types are extracted from the verbs' objects by a named entity recognition (NER) model. Since the NLP pipeline was originally designed for Android™ apps, ExtPrivA addresses the following challenges to handle the differences between the privacy policies of Chrome™ extensions and Android™ apps.

With respect to the scope of privacy policies, while Android™ apps typically have dedicated privacy policies, many browser extensions are found to use generic privacy policies that cover the data practices shared by the web services developed by the same developer. Most privacy policies include statements for multiple platforms (such as websites, apps, and extensions). For example, “Capital One Shopping systems capture email header data (sender, recipient, date and subject, not message bodies)” applies only when users grant inbox access. However, the current sentence-based privacy policy analysis techniques (such as PurPliance) cannot distinguish the scope of each statement (whether the statement is about the website or the extension) owing to the lack of a holistic whole-document analysis. Therefore, statements that do not mention extensions are excluded to reduce false positives. In particular, only the sentences that contain the keyword “extension” are included.

With respect to data ontologies, because the data type ontologies modeling data types and their relationship of Android™ apps are different from the relationships of browser extensions, they were augmented with the high- and low-level data types of the Web Store (Table 1). Similar to the domain adaptation in NLP, this addition is useful because privacy policies of Android™ apps do not include certain extension-specific data types, such as Website Content and Web History.

It will be appreciated that the steps 210 and 220 may be carried out simultaneously and/or together, at least in some embodiments.

According to one embodiment, extracted privacy statements are extracted from template-based dashboard disclosures by parsing the Privacy-Practice page of each extension while the open source PurPliance is leveraged to extract privacy statements from the privacy policies. For each extension, ExtPrivA parsed the overview page to obtain the URL of the privacy policy. The system then pre-processed and extracted the sentences from the policy using both rule-based methods and neural NLP models. The crawling and pre-processing of extensions' privacy policies are described below.

To obtain the privacy policy documents, for each extension, ExtPrivA extracts the privacy policy URL from the extension's overview page. In embodiments, a clean instance of Chrome™ browser is used that fully executes JavaScript to extract privacy policies of dynamic web pages. ExtPrivA then extracts plain text from the HTML by using PolicyLint preprocessing tool, as set forth in [B. Andow, S. Y. Mahmud, W. Wang, J. Whitaker, W. Enck, B. Reaves, K. Singh, and T. Xic. PolicyLint: Investigating Internal Privacy Policy Contradictions on Google Play. In 28^{th} USENIX Security Symposium (USENIX Security 19), pages 585-602, 2019.]. The plain text is then segmented into sentences by using a transformer-based neural model en_core_web_trf included in the Spacy NLP library [E. AI. spaCy·industrial-strength natural language processing in python. 2020. URL: https://spacy.io/(visited on Jan. 8, 2021).]. The method 200 continues to step 230.

In step 230, privacy contradiction data is determined between the dashboard disclosure privacy statements and the privacy policy statements. According to embodiments, this step includes determining mismatches between the dashboard disclosure statement data items and the privacy policy statement data items by comparing, for each dashboard disclosure statement data item of the dashboard disclosure statement data items, the collection indicator of the dashboard disclosure statement with the collection indicator of a corresponding privacy policy statement data item of the privacy policy statement data items.

According to embodiments, two privacy statements are considered to be contradictory when their data or receivers have subsumptive relationships (defined below) with each other while the statements have opposite sentiments (positive vs. negative, or collect vs. not_collect). For example, a contradiction occurs between “we do not collect your personal data” and “we may collect your location” because location subsumes under personal data while keeping the receivers the same. Logical contradiction rules in PolicyLint are leveraged to detect such contradictions and formalize them as follows. Two privacy statements (eⱼ,collect,dₖ) and (eⱼ,not_collect,dₗ) are contradictory if (dₖ⊆_{δ}dₗ dₗ ⊏_{δ} dₖ) and (eᵢ⊆_{∈}_{∈} eⱼ) in a data type ontology δ and an entity ontology E.

A challenge in detecting contradictions between dashboard disclosures and privacy policies lies with the differences between their data type ontologies that comprise the sets of data types and their subsumptive relationships. Specifically, the dashboard data types are defined by the Chrome™ Web Store and follow narrower definitions than those used in the privacy policies that contain broader statements about the websites, services, and extensions. For example, the term “personally identifiable information” in privacy policies includes “IP addresses” while the Store's definition does not. To resolve these differences and analyze privacy statements uniformly, the collection of the data types in dashboard disclosures are treated as normal sentences so that they are comparable with the statements in the privacy policy counterpart. For example, the collection of Location in FIGS. 5A-5B is treated as “we collect your location.” Therefore, the privacy policies' ontologies that are broader than the Store's ontologies are used to analyze the privacy-statement tuples in both privacy policies and dashboard disclosures. In particular, the datatype nodes and subsumptive-relationship edges in the Store's ontology graph are added into broader privacy policy ontologies. An advantage of this approach is that the unified ontologies can be used to detect the contradictions among the statements of the same privacy policies. While this approach excludes the generated negative-sentiment statements that require a complete declaration of all data types (see step 210 discussion), ignoring these statements do not generate any false positives. The method 200 continues to step 240.

In step 240, extension use data is generated for the extension based on data collected during operation of the extension. At least according to embodiments, generating the extension use data for the extension based on data collected during operation of the extension includes performing a network request initiator inspection process where an initiator of a network request is inspected to determine whether the network request was initiated from the extension. Also, according to embodiments, generating the extension use data includes extracting data types from one or more extension network requests so as to generate extension use data items, each of which includes a receiver and a data object that is sent as a part of the network request to the receiver.

Candidate URL Extraction: Since extensions do not have access to all websites by default, ExtPrivA first identifies the URLs of the websites that an extension has access to. To generate these URLs, ExtPrivA analyzes the extension manifest and extracts the URLs patterns for the background scripts, content scripts, and WAR resources declared in the host_permissions and matches keys in the manifest.

ExtPrivA generates a set of candidate URLs from each URL pattern. A pattern is first decomposed into 4 components, following the manifest format: scheme, subdomain, domain, and path. ExtPrivA then synthesizes the candidate URLs that match the specified URL patterns by substituting wildcard components with common valid values such as www for a subdomain. For example, from https://*.example.com/subpath/*, a candidate URL https://www.example.com/subpath/is generated. Inspired by Hulk [A. Kapravelos, C. Grier, N. Chachra, C. Kruegel, G. Vigna, and V. Paxson. Hulk: eliciting malicious behavior in browser extensions. In 23rd USENIX Security Symposium (USENIX Security 14), pages 641-654, 2014], for those patterns that match unspecified domains and paths such as <all_urls> and https://*/*, ExtPrivA selects top website domains in two categories, search and shopping, on which extensions commonly execute from the Tranco list [V. Le Pochat, T. Van Goethem, S. Tajalizadehkhoob, M. Korczynski, and W. Joosen. Tranco: A Research-Oriented Top Sites Ranking Hardened Against Manipulation. In Proceedings of the 26th Annual Network and Distributed System Security Symposium, 2019.]. These URLs are listed in Table 2 below.

TABLE 2
Testing URLs for generating candidate URLs.

| Category | URL |
|---|---|
| Search | https://www.google.com/search?q=statistics&hl=en |
| | https://www.bing.com/search?q=statistics |
| Shopping | https://www.amazon.com/gp/product/B085TFF7M1 |
| | https://www.amazon.com/dp/B07G7T3M6C |
| | https://www.ebay.com/itm/323879722346 |
| | https://www.aliexpress.com/item/4000901174719.html |

Test pages: To test the extensions, two types of web pages may be used: real pages and honeypages. The former is real world web pages that are served either from the Internet and a web-page replay server. In contrast, the latter (or a honeypage) refers to a specially-crafted web page that is based on prior extension analysis work [M. Xie, J. Fu, J. He, C. Luo, and G. Peng. JTaint: finding privacy-leakage in chrome extensions. In Information Security and Privacy, pages 563-583, 2020.] and contains various HTML elements to trigger common functionality of extensions. The HTML elements include text and password input elements which use privacy sensitive keywords (e.g., username, name, and city) for their HTML attributes (e.g., id, name, and class). Real pages are useful for extensions that execute based on the structure of websites where the honeypage cannot be replicated. For example, the honeypage cannot emulate real complex websites like Amazon shopping pages.

In regard to user interaction emulation, to trigger the data collection functionality of extensions that operate upon user activities, interaction templates were designed based on browser, mouse, and keyboard actions. These actions are the main user interaction categories expected to execute extension functionality. The interaction templates were reimplemented and further customized them for specific websites. For example, a different element selector is used depending on whether the browser is accessing a Google search result page or an Amazon product page. ExtPrivA performs the following templates after a web page is fully loaded: Text Selection and Mouse Actions; Keyboard Input and Form Submission; and Interaction with New Tab Pages, which are discussed below.

Text Selection and Mouse Actions: To elicit potential data collection on the text selected on a web page, ExtPrivA selects a word and activates the extension via the extension icons on the menu bar and/or the context menu. For example, a dictionary extension shows the definition of a selected word after the user selects the word, clicks the right mouse button, and selects the extension icon on the context menu. Therefore, ExtPrivA performs mouse scrolling and clicking to select the text to trigger extensions that operate upon mouse events (e.g., clicks, double-clicks). When the web page is the honeypage or a replayed page, the text of a fixed element is selected. Otherwise, ExtPrivA selects the first word of the <body> element that is expected to exist on any web page. This interaction template already includes a click on the extension icon on the browser menu bar. For example, a shopping assistant shows the information of products on amazon.com only when the user clicks on its menu-bar icon. This interaction is called extension action (Manifest V3) or browser action (Manifest V2) and is one of the main entry points that trigger the functionality of extensions.

Keyboard Input and Form Submission: To trigger extension functionality that monitors keyboard events, ExtPrivA inputs a keyword into a form field on the honeypage, issues a copy command via ctrl+c, and submits the input form to a server endpoint. For example, spelling checkers may monitor keyboard typing and suggest a correction. ExtPrivA inputs a special value, called bait, to detect the extension's collection of keyboard input, such as through use of the bait technique discussed in [G. Acar, S. Englehardt, and A. Narayanan. No boundaries: data exfiltration by third parties embedded on web pages. Proceedings on Privacy Enhancing Technologies, (4): 220-238, 2020.].

Interaction with New Tab Pages: To trigger the extensions that provide a customized new tab page, ExtPrivA opens a new tab and types in a keyword. For example, the Infinity New Tab extension opens a customizable tab that lets users enter a search term and shows the current weather forecast. This kind of extension may collect user location and/or search terms without the user's awareness.

At least in some embodiments, as mentioned above, generating the extension use data for the extension based on data collected during operation of the extension includes performing a network request initiator inspection process where an initiator of a network request is inspected to determine whether the network request was initiated from the extension. This process may be executing during generation of the data collected during operation (and may be a part of that data) so that the call stack and/or other initiator information may be stored and/or used to inform the inconsistency analysis. Below is a discussion of a network request initiator inspection process, according to one embodiment. As used herein, a “network request initiator inspection process” is a process where an initiator of a network request is inspected to determine whether the network request was initiated from the extension.

It is challenging to extract the data traffic originated from an extension because the HTTP requests sent from the browser do not differentiate between those sent by extensions and those sent by web pages. Therefore, ExtPrivA extracts extensions' data traffic by analyzing the request-initiator scripts and the HTTP Origin header as follows.

First, ExtPrivA leverages the call stack information of script-initiated network requests provided by the network activity inspection of Chrome's DevTools. In DevTools, an initiator of a network request can be one of 6 types such as a JavaScript script or HTML parser. An extension's script, like other extension's resources, has its URL in the form of chrome-extension://<extension-id>/path-to-script (identifying extension IDs is described in Extension ID Determination section). Since the initiator information of a script contains call frames which include the initiated scripts' URLs in the call stacks, if a script URL is prefixed by a chrome-extension scheme and matches the extension ID, the traffic is initiated by the extension. While content scripts execute in web pages' contexts, DevTools captures the requests of content scripts. However, it indicates chrome-extension://initiators for content scripts but not for injected inline scripts. Second, ExtPrivA utilizes the Origin HTTP request header which is non-programmatically modifiable to indicate the security contexts that cause the browser to initiate an HTTP request. This header is set to chromeextensions://<extension-id> if the request is initiated by an extension. External scripts in the background or pop-up pages of the extension do not have URLs with the chrome-extension scheme, and thus cannot be identified by using the call stacks in the script initiators. Using the Origin header can identify the requests initiated by such embedded external scripts.

According to some embodiments, generating the extension use data includes extracting information from HTTP traffic, such as that which is identified as originating or being initiated at the extension, as previously discussed.

ExtPrivA parses HTTP requests in the extension traffic intercepted in the prior step into key-value pairs since structured responses are widely used by web services. The key-value pairs are extracted from the sent cookies, URL query strings, and request bodies of HTTP POST messages. In the dataset used herein, while most of the traffic is plaintext, when encountering encoded traffic, ExtPrivA attempts to decode the data by using multiple rounds of Base64 decoding. This decoding is based on the technique used by [O. Starov and N. Nikiforakis. Extended tracking powers: measuring the privacy diffusion enabled by browser extensions. In Proceedings of the 26th International Conference on World Wide Web, pages 1481-1490, 2017]. However, ExtPrivA cannot extract data flows from the data traffic encrypted by extensions.

Unlike automatic data, such as IP addresses as part of the IP protocol or information in the HTTP security headers, sending data via URL parameters or the POST body generally requires a significant effort to obtain and set the values correctly. In particular, obtaining and adding personal data to URL parameters require developers' time and effort, unlike the IP addresses that browsers automatically set. Therefore, the occurrences of these values in the transferred data are unlikely created by the extension developers by accident. To further reduce false positives of unintentional data leakage, key-value pairs were excluded in HTTP headers (other than the Cookie header) because the headers may include information automatically set by the browser rather than intentionally set by the extension.

In embodiments, key-value pairs sent to the servers that had the same hostname as the currently visited web page are filtered out because the web page had already collected the user's data. For example, if a user visits host H=sub.example.com, extensions' traffic to H is excluded. It is unclear whether the extensions are leaking data because the user already shared data with H. However, this filtering of same-host traffic does not create false positives and excludes only 0.81% (381/47,207) of extensions.

Provided below are implementation details, including Analysis Pipeline, Traffic Interception, Extension ID Determination, and Testbed details, according to one embodiment.

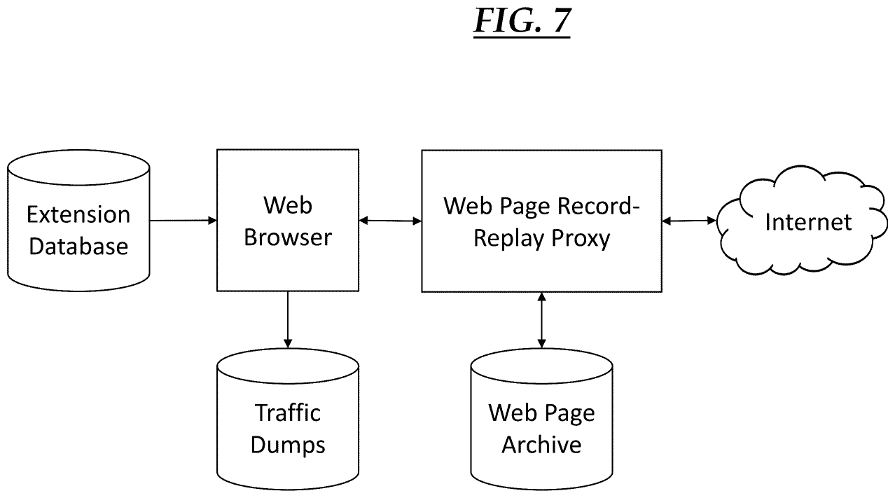

Analysis Pipeline: ExtPrivA performs dynamic analysis and captures data traffic of the extensions using an analysis pipeline as shown in FIG. 7. Each extension is initially loaded to a clean browser instance that disables updates and other unnecessary background traffic such as user-metrics reporting to avoid noisy traffic, following the measurement procedure of Chromium™ telemetry framework. The browser then records the traffic of the extensions and loads web pages via a web page record-replay proxy. The browser employs mechanisms to avoid bot detection that has been known to affect the real behavior of websites. ExtPrivA utilizes the Playwright™ browser automation tool to drive an instance of the Chromium™ web browser. Extensions are loaded to browser instances that display to a virtual X11 frame buffer (Xvfb) as the browser does not support loading extensions in the headless mode. The keyboard keystrokes are sent to the browser instances via the X11 server using the xdotool. To trigger an extension action (i.e., a click on the extension menu-bar icon), ExtPrivA instruments the manifest to set the shortcut keys to perform the extension actions because the browser automation tool can only interact with web pages' contents but not the interface of the browser. To make the experiments reproducible, a web page replay (WPR) proxy, a modified version of the Chromium™ WPR tool, is employed, which allows one to record, replay and passthrough network requests and responses. The WPR proxy replays website contents for reproducibility while allowing the browser extensions to communicate with the Internet to capture the extensions' realistic behavior. Because the WPR proxy passes through dynamic requests that had not been prerecorded, it tests extensions on dynamic contents while replaying static content to avoid additional traffic to websites. In the record mode, the WPR proxy records the responses of web pages by using the browser with no installed extensions. In the replay mode, the proxy passes through requests which are not found in the WPR proxy's recorded request store. In particular, the most commonly visited web pages were recorded and replayed. The browser was set up to whitelist the SSL certificates for the WPR proxy to capture and replay encrypted HTTPS traffic.

Traffic Interception: To intercept the traffic generated by the JavaScript's XHR requests, ExtPrivA utilizes the Chrome™ DevTools Protocol (CDP) to extract the network traffic from a web page to servers. ExtPrivA creates a CDP session via Playwright to send commands and receive events from the DevTools in the browser instance. Specifically, ExtPrivA enables network tracking functionality of the DevTools and extracts information from the network events. The request tracing information contains a request initiator which can be the DOM parser or a script. Since the browser treats a background page as a regular web page, ExtPrivA captures the network traffic of background pages of Chrome™ extensions separately.

Extension ID Determination: To accurately extract the network traffic originating from an extension, ExtPrivA determines the extension's ID which is unique in the browser instance. The system adds a key value to the manifest to make the extension ID non-randomized. ExtPrivA then extracts the extension ID from the preference configuration file in the browser's user data directory and also verifies the loaded extension path.

Testbed: To perform experiments in a large dataset of extensions, a distributed experimental framework was created to run the dynamic analysis on multiple machines. The testbed is replicated and run in identical and isolated environments. The framework is based on Docker Swarm and the browser is started with arguments to make it run in the resource constrained docker environments.

Given the data traffic of an extension collected, ExtPrivA extracts data flows that formally represent the data-collection behavior of the extension. A data flow is formalized in the following definition. A data flow is a tuple f=(r,d) where a receiver r receives a data object d.

Extraction of data flows is discussed below, and is organized into a discussion first on the extraction of data types and then a discussion on the extraction of data receivers.

In regard to the extraction of data types, data types are selected and a rule-based extractor is designed as follows. Of the Store's 9 data types, four (4) context-free data types are chosen for extraction whose meanings does not depend on their usage contexts: Website Content, Web History, Location, and User Activity. It is challenging to extract context-sensitive data types because the lack of the server-side information oftentimes makes it practically impossible to determine the ultimate usage purposes of the collected data. Moreover, these data types (e.g., PII and authentication information) are included in Website Content. For example, if a user enters a home address in a Google search box while extension 24 records every input to the search box, it is not possible to determine whether extension 24 intentionally collects home addresses (PII) or only website content by solely analyzing data traffic.

ExtPrivA extracts eleven (11) low-level data types under the high-level data types as listed in the table below.

TABLE 3
List of the high-level and low-level data types supported by ExtPrivA.

| High-level Type | Low-level Type | Matching Pattern |
|---|---|---|
| Web History | Page Title* | Exact match of page title |
| | Page URL | Exact match of page URL |
| | Page Hostname | Exact match of page hostname |
| Website Content | Hyperlink* | Hyperlinks in <a> elements |
| | Website Text* | bait text value |
| | Product ID | Product ID on shopping sites |
| Location | IP Address* | IP addresses of testbed servers |
| | Region* | <city_name>, <zip_code> |
| | GPS Coordinates* | Coordinates of testbed servers |
| User Activity | Mouse Click* | ui.click events |
| | Keystroke Logging* | ui.input events/partial bait input |

*marks the examples of low-level data types provided by the Chrome ™ Web Store.

Because the Store provides only several examples rather than an exhaustive list of low-level data types, the following examples were added for their privacy significance and relevance to experiments. Page URL is one of the “browsing-related data”, a definition of the Store for the Web History, and can be used to exactly determine the page that a user visited. Similarly, Page Hostname reveals a user's browsing habits while extensions frequently break a page URL into a hostname and a URL path before sending them to external servers. Finally, Product ID is considered separately for analyzing shopping-assisting extensions during user visits to shopping sites like Amazon™ and eBay™.

While adding the low-level data types widens the scope of the high-level types, any addition that makes the high-level data types overlap and become ambiguous is avoided. In particular, some low-level data types overlap (such as Page URL and Page Hostname) but one low-level data type does not simultaneously fall into different high-level data types.

With regard to the extractor design, the extraction of data types from a key-value pair is formulated as a classification problem. For each low-level data type, a classifier is created that determines whether the key-value contains the data type or not. To achieve low false positives (high precision), classifiers are designed based on pattern-matching rules as follows. To extract Website Content and Web History data types, ExtPrivA searches for the content and the URL of the currently visited web page in the transferred key-values. For example, if the traffic contains an exact match of the URL of the webpage, the extension collects the currently visited URL or the Web History data type. Similarly, for certain websites, an ID is searched for in the URL such as an item ID on amazon URLs (e.g., amazon.com/dp/ABC where the last part of the URL, ABC, is the item ID). Based on the bait technique, in addition to the existing website content, the bait value contained in the honeypage in the traffic is searched for. The bait is selected to avoid collision with other common keywords in the traffic key-values so that its occurrence in the traffic indicates the collection of the Website Content. To detect the collection of User Activity, API documentation and the bait technique are relied upon. Specifically, it was found that many extensions utilized the popular Sentry monitoring library to monitor the keyboard input and mouse clicks. In particular, “ui.click” and “ui.input” are used for a mouse click and keyboard input events, respectively. Furthermore, after ExtPrivA inputs a bait keyword W via keyboard, if only part of W, but not the whole W, exists in the traffic, the extension is considered to have monitored keystrokes.

With regard to development of data type matching rules, the widely-used bootstrapping procedure may be followed in which the set of patterns is built iteratively with minimal human intervention. To create the seed matching patterns for a data type T, an exploratory study is performed on the data traffic of the extensions that disclosed their collection of T. Using a set of patterns, a set of matching key-value pairs were found and used to discover the new patterns. The process is then repeated while retaining only the most reliable patterns after each iteration. The final patterns were found to change only slightly with carefully-tuned seeds and are listed in Table 3.

With regard to extraction of data receivers, given a data type extracted from a key-value pair, the receiver of the corresponding data flows is set to the extension that sent the data and the external server where the data is sent, regardless of the ownership of the external server. Because a key-value is transferred to an external server by the execution of an extension, the extension must first collect the data from the browser or web pages before sending it to the external server. The data types extracted by ExtPrivA (Table 3) are dynamic data that require the execution of a script or API call to retrieve their values, rather than static/hard-coded data like an extension's version. For example, when an extension sends a user's mouse clicks to google-analytics.com for its development-analytics purposes, the extension is considered to collect the user activity even if it does not own the Google™ Analytics server.

Even when an extension directly shares user data with third parties, it poses high privacy risks to users if the users are not aware of the collection of their data due to the execution of the extension. For example, when a translation extension transmits the user-selected text to an external spelling-checking service, the user needs to be aware of such data collection to avoid inadvertently selecting sensitive data, such as an email with a trade secret, to be sent to an external spell checker. The method 200 continues to step 250.

In step 250, inconsistencies between extension data practice and an extension data policy are determined based on the dashboard disclosure privacy statements, the privacy policy statements, and the extension use data. The term “extension data practice” refers to an extension's practice with respect to its handling of user data, and the term “extension data policy” refers to a policy stated or set forth with respect to handling of user data by an extension.

ExtPrivA detects the inconsistencies between an extension's actual data collection and its privacy-practice disclosures by analyzing the (in) consistencies between the extracted privacy statements (see discussion of steps 210-230) and data flows (see discussion of step 240). As data flows and privacy statements are expressed in different terms and granularity, in order to check their (in) consistencies, ExtPrivA leverages ontologies of data types and receiving entities that represent the relationship between terms to perform logical comparisons between the statements and flows. An ontology o can be represented as a directed graph of data type terms where each edge between two nodes x and y points from a more general term y to a more specific term x. For example, there is an edge from Website Content to Hyperlink data type.

Def. 1 (Semantic Equivalence) Two terms x and y are semantically equivalent in an ontology o, denoted as x≡ₒ y, if and only if they are synonyms in o.

Def. 2 (Subsumptive Relationship) Two terms x and y have a subsumptive relationship (i.e., x has an “is-a” relationship with y) in an ontology o, denoted as x⊏ₒ y, if there are a series of terms x₁, x₂, . . . , xₙ₋₁ (n∈ [symbol] and n≥1) such as x⊏ₒ x₁ x₁ ⊏ₒ x₂, . . . , and xₙ₋₁ ⊏ₒ y. Similarly, x⊆ₒ y⇔z≡ₒ y∨x⊏ₒ y.

Def. 3 (Policy Logical Contradiction) Two privacy statements (eᵢ, collect, dₖ) and (eⱼ,not_collect,dₗ) are contradictory if (dₖ ⊆_{δ} dₗ or dₗ ⊏_{δ} dₖ) and (eᵢ ⊆_{∈} eⱼ) in a data type ontology δ and an entity ontology ϵ.

Def. 4 (Flow-Relevant Privacy Statement) A privacy statement s_{f}=(r_{f},c,d_{f}) is said to be relevant to a flow f=(r,d) if and only if the flow's receiver and data object are subsumed under the corresponding terms of the statement, i.e., r⊆_{∈} r_{f} and d⊆_{δ} d_{f} in an entity ontology ∈ and a data type ontology δ.

Def. 5 (Flow-to-Policy Consistency) A data flow f is said to be consistent with a set of privacy statements S={s} if and only if the set of flow-relevant privacy statements S_{f} ⊂S contains a positive-sentiment and no negative-sentiment privacy statement, i.e., ∃s_{f}=(r_{f},c,d_{f})∈S_{f} s.t. c=collect and [symbol] s′_{f}=(r′_{f}, c′, d′_{f})∈S_{f} s.t. c′=not_collect.

In the present embodiment, a “privacy statement” is a tuple s=(r,c,d) where r is a receiver that collects or does not collect (c∈{collect,not_collect}) a data type d.

Informally, given privacy disclosures that comprise a set of privacy statements, a flow is consistent with the disclosures if there is a positive-sentiment statement that states the collection of the data type in the flow while there is no negative-sentiment statement that describes the “non-collection” of the data. For example, a flow f=(extension,selected text), where the selected text in the currently visiting web page is collected by the extension, has a relevant statement that “we collect the website content” because website content includes the selected text (i.e., selected text⊏website content) and we≡extension. The flow is then consistent with the disclosures if there is not any relevant statement that states otherwise.

A flow-to-policy inconsistency occurs when the Consistency Condition (Def. 5) is not satisfied. The types of the inconsistencies may be classified into Correct Disclosure and Incorrect Disclosure. A Correct Disclosure occurs when the Consistency Condition holds and an Incorrect Disclosure happens if the condition does not hold. For example, a flow (extension, selected text) is inconsistent with privacy disclosures if there is a negative statement (extension, not_collect, website content).

In embodiments, inconsistencies between the extension behavior and the dashboard disclosures may be focused in on since they follow the same extension-specific data type ontologies defined by the Chrome™ Web Store. Comparing the data-collection behavior with the privacy policies requires resolving the semantic gap between the data types defined in the Store and the common policies (see discussion of step 230 and privacy statement contradiction discussion) while the flow extraction is designed based on the Store's data type ontologies. Furthermore, the inconsistencies between the data flows and privacy policy documents have already been studied before. Finally, because the complete list of data types is defined by the Store, this flow-to-policy consistency analysis utilizes the negative sentiment privacy statements for the undeclared data types as described above. The method 200 ends.

Below is a discussion of an embodiment of a flow-to-policy inconsistency analysis that was used as a part of implementing an embodiment of a method of detecting inconsistencies between privacy policy disclosures and practices. More particularly, an in-depth analysis of the flow-to-policy inconsistencies of the extensions on the Chrome™ Web Store was performed, and the experimental setup and results are presented below.

For extension selection, a crawler was designed and used to collect extensions on the Chrome™ Web Store. By following the Store's sitemaps, the crawler systematically visited and extracted the source code and description of each extension. The data collection was done by a server located in the U.S., and took 18 hours to complete.

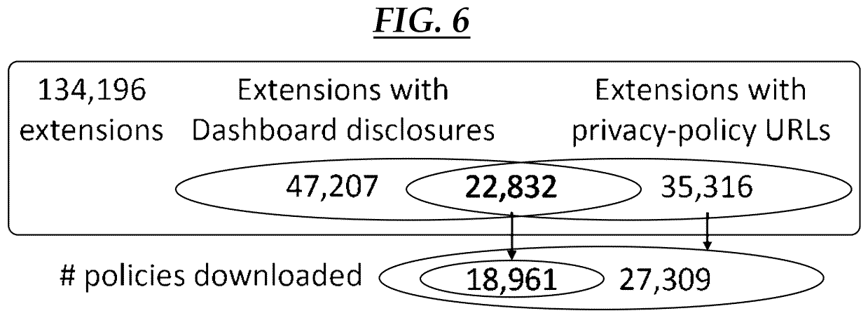

The total number of extensions collected was 134,196. There were 35,316 (26.32%) extensions providing a privacy policy URL while 12,484 of them had no dashboard disclosures. ExtPrivA downloaded and extracted plain text versions of the privacy policies of 27,309/35,316 (77.33%) extensions while the remaining policy URLs were inaccessible. Besides, a significant number of extensions, 74,505 (55.52%), provided neither dashboard disclosures nor privacy policy URLs. FIG. 6 shows the number of the privacy-disclosure types. In the following experiments, the 47,207 (35.18%) extensions that declared the dashboard disclosures were considered. The disclosures have been required for the publication of an extension on the Chrome™ Web Store since March 2021. Recently, there has been observed a significant increase of extensions with dashboard disclosures and, thus, it is assumed that extensions on the Store will gradually include dashboard disclosures.

With regard to policy and flow characterization, the majority of extensions state not to collect any user data while a significant number of extensions state collection of only 1 data type. Of the extensions with dashboard disclosures, 33,787/47,207 (71.57%) state that they do not collect or use any user data while 15.97% of the remaining extensions state the collection of only 1 data type. Extensions that collect only 1 data type are the most common. For each data type, the number of extensions that declared the data collection is also small. The most common data type collected by the extensions is Website Content (13.5%) while the least common is Health Information (0.29%).

Of the 47,207 extensions with dashboard disclosures, 22,832 (48.37%) contain privacy policy URLs. From these URLs, 18,961 (83.05%) privacy policies were successfully downloaded. The system then extracted 8,012 extension-related privacy statements from 2,091 extensions' privacy policies. Because of the exclusion of the statements that do not mention browser extensions, ExtPrivA did not include the policies from the remaining extensions. Of these privacy statements, 6,238 (77.86%) have a negative sentiment and 1,774 (22.14%) have a positive sentiment. 1,538 extension policies contain negative sentiment statements that discuss broad categories of data. Of the statements with a negative sentiment, the data object “personally identifiable information” or “PII” appears in 1,280 of these extensions. This high percentage highlights the significance of negative privacy statements as 83.22% (1,280/1,538) of the extensions contain a negative sentiment that excludes the collection of a broad data type.

Below an experimental setup is discussed regarding an extension E, which corresponds to the extension 24 (FIG. 1) discussed above. Given extension E, ExtPrivA first identifies the candidate URLs to activate the extension's functionality (see discussion of step 240). The system then visits each of the identified URLs in a clean browser instance with the extension E installed at each start-up while disabling other extensions to reduce execution and traffic noise. For each URL, the system visits a real page and a honeypage. If the URL has been recorded by the Web Page Replay proxy, the network requests are redirected to the proxy to reduce loads on the server side while improving the reproducibility of the experiments. Since the number of the candidate URLs can be large, for each extension, ExtPrivA visits the URLs until either all URLs or a maximum of 10 URLs are visited. For each URL, the browser waits until the home pages are fully loaded by waiting until there are no network connections within a timeout of 5 seconds or a maximum of 30 seconds. Because the experimental servers used a fast Internet connection, it was empirically found that these timeouts were sufficient to completely load most of the web pages. The page loading heuristics are commonly used in the empirical settings and provided as the default in the web browser automation tools. Finally, ExtPrivA interacts with the browser to activate the functionality of the extension. It is worth noting that an experiment does not raise false positives if the extension is not successfully loaded or its functionality is not activated. The analysis was performed on a cluster of 8 machines with 1.18 TB of RAM in a university in the U.S. and took 70 hours to complete.

From the 47,207 extensions that provide Dashboard disclosures, 129,218 candidate URLs on 28,618 domains were extracted. The distribution of the domains has a long tail with only 248 domains with a frequency greater than 100. The most common extracted domains are yahoo.com and google.com which involve a large number of country-specific subdomains for their services. The third most common domain is coolstart.com which hosts a new-tab page for numerous new-tab-customization extensions.

ExtPrivA activated the extensions' functionality, captured their network traffic, and extracted 680,923 key-value pairs sent from 3,904 extensions to 3,280 unique hosts and 6,902 external server endpoints each of which is a combination of a host and a path. The most common host is www.google-analytics.com (80,171/680,923 (11.77%) key-value pairs). The high percentage of traffic to Google Analytics indicates its popularity among the extensions for data collection. To activate an extension's functionality, ExtPrivA visited 5.1 candidate URLs on average (1.82 SD). The numbers of the unique web page URLs and website domains on which the extensions generated the data traffic are 1,532 and 1,381, respectively.

From the traffic key-value pairs, ExtPrivA extracted 1,706 unique data flows for the data types received by 1,002 extensions. Each extension collects 1.7 data types on average (1.04 SD). The most common data types extracted from the extensions are the URLs and hostnames of the currently visited webpages, which are under the Web History high-level data type. Such data types are privacy-sensitive as they can be easily used to construct a user's web browsing habit.

In the present embodiment, PurPliance was adopted to determine the functionality of data-flow receivers based on extension descriptions and well-known advertising/analytics provider lists. First, rather than using Android™ package names, first-party domains were extracted as the domains of the privacy policy URL and publisher websites on each extension description webpage. Second, PurPliance's mobile ad and tracking filters were replaced with those designed for websites to identify online advertising networks and analytics providers. Third, to improve coverage further, if a host did not fall into these lists, it was matched with the 1 Hosts Xtra list to identify online trackers. Finally, if a receiver was not identified by these ad filtering lists, it was classified as Other.

In general, the most common receiver types are extensions' own hosts (first parties) and analytics providers. The first-party hosts have a long-tail distribution with 312 unique hosts for 524 flows. The most common first-party and analytics hosts are bar.maxtrigger.com (15/524 flows) and www.google-analytics.com (76/314 flows), respectively. Online trackers and ad networks are less common than analytics services. The most common tracker and ad network hosts are sentry.io (12/166 flows) and adservice.google.com (32/51 flows), respectively. The Other hosts that were unidentified by the lists of well-known ad/analytics services have a longtail distribution, which comprises 163 hosts for 651 flows and includes service hosts such as the Google Cloud Translation end point translate.googleapis.com.

To understand the purposes of data collection, the privacy statements that were relevant to consistent data flows based on Definitions 4 and 5 were extracted, and extracted data-usage purposes from the statements using PurPliance. Of the 1,706 flows extracted from 1,002 extensions, 20 privacy statements of 11 sentences with data-usage purposes which were relevant to 21 unique flows of 13 extensions were identified. Since each flow may have multiple purposes, the flows were expanded to 28 flows so that each flow has exactly one usage purpose. The number of flows with specified purposes is not high because only part of privacy statements in a privacy policy specifies purposes (e.g., 25.8% of statements for Android apps) even in cases where statements were narrowed down to only extension-related ones. The results show that extensions primarily collected data for improving (14/28 flows) or providing services (10/28 flows). The most common data types are Website Content (Hyperlink and Product ID) and Web History (Page URLs of the currently visiting pages). Notably, three flows of an extension collected the data types for third-party advertising purposes by stating “We may share aggregate information about how our users use www.valurank.com or the extension with advertisers, business partners, sponsors, and other third parties”. However, the Web Store's Limited Use policy prohibits any transfer of user data to advertisers. The extracted purposes do not contain the full spectrum of data-usage purposes as when the entire privacy policy is analyzed. To validate PurPliance's purpose extraction, two authors independently labeled the 11 extracted sentences using the purpose classes in PurPliance's purpose taxonomy. Twenty-four (24) purposes of the 11 sentences were identified and the purpose extraction had 95.00% (19/20) precision and 79.17% (19/24) recall. The precision is high, as PurPliance extraction uses strict rule-based matching, and is comparable to PurPliance's results.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of detecting inconsistencies between privacy policy disclosures and practices, comprising the steps of:
generating dashboard disclosure privacy statements based on dashboard disclosure data for an extension;
generating privacy policy statements based on privacy policy data for the extension;
determining privacy contradiction data between the dashboard disclosure privacy statements and the privacy policy statements;
generating extension use data for the extension based on data collected during operation of the extension; and
determining inconsistencies between extension data practice and an extension privacy policy based on the dashboard disclosure privacy statements, the privacy policy statements, and the extension use data.

2. The method of claim 1, wherein the dashboard disclosure privacy statements are extracted as dashboard disclosure statement data items, each of which includes a receiver identifier, a collection indicator, and a data type identifier.

3. The method of claim 2, wherein the privacy policy statements are extracted as privacy policy statement data items, each of which includes a receiver identifier, a collection indicator, and a data type identifier.

4. The method of claim 3, wherein the determining privacy contradiction data between the dashboard disclosure privacy statements and the privacy policy statements includes determining mismatches between the dashboard disclosure statement data items and the privacy policy statement data items by comparing, for each dashboard disclosure statement data item of the dashboard disclosure statement data items, the collection indicator with the collection indicator of a corresponding privacy policy statement data item of the privacy policy statement data items.

5. The method of claim 3, wherein the determining privacy contradiction data between the dashboard disclosure privacy statements and the privacy policy statements includes determining subsumptive relationships between the receiver identifiers and the data type identifiers.

6. The method of claim 5, wherein determining the subsumptive relationships between the receiver identifiers includes determining whether there exists a subsumptive relationship between the receiver identifier of a first privacy policy statement data item and the receiver identifier of a second privacy policy statement data item.

7. The method of claim 5, wherein determining the subsumptive relationships between the data type identifiers includes determining whether there exists a subsumptive relationship between the data type identifier of a first privacy policy statement data item and the data type identifier of a second privacy policy statement data item.

8. The method of claim 1, wherein generating the extension use data for the extension based on data collected during operation of the extension includes performing a network request initiator inspection process where an initiator of a network request is inspected to determine whether the network request was initiated from the extension.

9. The method of claim 1, wherein generating the extension use data includes extracting data types from one or more extension network requests so as to generate extension use data items, each of which includes a receiver and a data object that is sent as a part of the network request to the receiver.

10. The method of claim 1, wherein the extension is a browser extension for a web browser.

11. The method of claim 1, wherein the method is performed by at processor executing computer instructions stored on non-transitory, computer-readable memory.

12. An automated data collection-disclosure consistency determination system, comprising:
at least one processor; and
memory storing computer instructions;
wherein the automated data collection-disclosure consistency determination system is configured so that, when the computer instructions are executed by the at least one processor, the automated data collection-disclosure consistency determination system:
generates dashboard disclosure privacy statements based on dashboard disclosure data for an extension;
generates privacy policy statements based on privacy policy data for the extension;
determines privacy contradiction data between the dashboard disclosure privacy statements and the privacy policy statements;
generates extension use data for the extension based on data collected during operation of the extension; and
determines inconsistencies between extension data practice and an extension privacy policy based on the dashboard disclosure privacy statements, the privacy policy statements, and the extension use data.

13. The system of claim 12, wherein the dashboard disclosure privacy statements are extracted as dashboard disclosure statement data items, each of which includes a receiver identifier, a collection indicator, and a data type identifier.

14. The system of claim 13, wherein the privacy policy statements are extracted as privacy policy statement data items, each of which includes a receiver identifier, a collection indicator, and a data type identifier.

15. The system of claim 14, wherein the determining privacy contradiction data between the dashboard disclosure privacy statements and the privacy policy statements includes determining mismatches between the dashboard disclosure statement data items and the privacy policy statement data items by comparing, for each dashboard disclosure statement data item of the dashboard disclosure statement data items, the collection indicator with the collection indicator of a corresponding privacy policy statement data item of the privacy policy statement data items.

16. The system of claim 14, wherein the determining privacy contradiction data between the dashboard disclosure privacy statements and the privacy policy statements includes determining subsumptive relationships between the receiver identifiers and the data type identifiers.

17. The system of claim 16, wherein determining the subsumptive relationships between the receiver identifiers includes determining whether there exists a subsumptive relationship between the receiver identifier of a first privacy policy statement data item and the receiver identifier of a second privacy policy statement data item.

18. The system of claim 17, wherein determining the subsumptive relationships between the data type identifiers includes determining whether there exists a subsumptive relationship between the data type identifier of a first privacy policy statement data item and the data type identifier of a second privacy policy statement data item.

19. The system of claim 12, wherein generating the extension use data for the extension based on data collected during operation of the extension includes performing a network request initiator inspection process where an initiator of a network request is inspected to determine whether the network request was initiated from the extension.

20. The system of claim 12, wherein generating the extension use data includes extracting data types from one or more extension network requests so as to generate extension use data items, each of which includes a receiver and a data object that is sent as a part of the network request to the receiver.
